(19) United States
(12) Patent Application Publication
(10) Pub. No.: US 2013/0242573 A1
(43) Pub. Date: Sep. 19, 2013

(54) LED Light Fixture With Improved Thermal Management

(71) Applicants: James T. Petrsoki, Parma, OH (US); Bradley E. Reis, Westlake, OH (US); Julian Norley, Chagrin Falls, OH (US); John Schober, Broadview Heights, OH (US); Robert A. Reynolds, III, Bay Village, OH (US); Yin Xiong, San Diego, CA (US)

(72) Inventors: James T. Petrsoki, Parma, OH (US); Bradley E. Reis, Westlake, OH (US); Julian Norley, Chagrin Falls, OH (US); John Schober, Broadview Heights, OH (US); Robert A. Reynolds, III, Bay Village, OH (US); Yin Xiong, San Diego, CA (US)

(73) Assignee: GRAFTECH INTERNATIONAL HOLDINGS INC., Parma, OH (US)

(21) Appl. No.: 13/512,976

(22) PCT Filed: Dec. 14, 2009
(86) PCT No.: PCT/US09/67924

§ 371 Date: Apr. 2, 2013

(30) Foreign Application Priority Data
Dec. 14, 2009 (US) PCT/US09/067924

(51) Int. Cl. F21V 29/00

(52) U.S. Cl. CPC F21V 29/002
USPC 362/373

(57) ABSTRACT

A light fixture (10), having a circuit board (20) having first and second major surfaces (20a and 20b); at least one light emitting diode (25) mounted on the first major surface (20a) of the circuit board (20); an enclosure (30) formed of a material having two major surfaces (30a and 30b) and a thermo-mechanical design constant of at least 20 mm-W/m*K and shaped so as to define an opening (32) and a cavity (33), one of the major surfaces (30a) of the material defining the surface of the cavity (33) and the enclosure (30) positioned so as to enclose the second major surface (20b) of the circuit board (20); a heat spreader (40) having a surface area at least twice that of the circuit board and a thermo-mechanical design constant of at least 10 mm-W/m*K, the heat spreader (40) positioned in thermal contact with both the circuit board (20) and the enclosure (30).

### TECHNICAL FIELD

The present disclosure relates to a light emitting diode (LED) light fixture, having improved thermal management. More specifically, the present disclosure relates to a light fixture which includes a circuit board having an LED mounted thereon, and an enclosure protecting the circuit board from, e.g., the elements. The enclosure includes a heat spreader which is in thermal contact with both the enclosure and the circuit board, to improve thermal management of the light fixture.

### BACKGROUND ART

LEDs have become more efficient and cost effective for white lighting since the introduction of high brightness blue wavelengths. As the LED costs have dropped, the efficacies raised, and the amount of light per device increased steadily, new applications for LEDs have come into use. Recent levels of LED performance are now enabling applications across many fields, from specialty lighting (jewelry cases, refrigeration/freezer units, surgical lighting) to indoor general lighting (spot lights, recessed lighting) to outdoor general lighting (post lamps, parking lot/area lamps, parking garage lamps).

Large LED array lights are currently being designed and sold as replacements for lights on roadways, tunnels, parking lots and other large areas. These lights are typically 75 W to 200 W in thermal dissipation, and the lighting structure is designed to handle a predominately conductive heat path until contact with the outer air is made, at which point convection to the ambient air removes the heat from the system. To handle this internal conduction path to a suitable area for convection, most LED array lights have been developed using a metallic, especially an aluminum, heat sink, which causes a weight problem and additional costs over conventional light systems which are manufactured with sheet metal. More particularly, such metallic heat sinks can add significant cost and weight to a light fixture, especially since production of the casting or extrusion tool, or the injection mold, used to form the heat sink is so difficult and time consuming, and the tools/molds do not last long and cannot be easily modified, especially as compared with sheet metal dies. Conventional sheet metal designs are deficient in providing an adequate thermal path for the LED thermal dissipation.

Accordingly, what is sought is an LED light fixture having improved thermal management. In certain embodiments, the improved thermal management is achieved without the need for heavy and expensive extruded, injection molded or die-cast metallic heat sinks.

Graphite flake which has been greatly expanded and more particularly expanded so as to have a final thickness or “c” direction dimension which is as much as about 80 or more times the original “c” direction dimension can be formed without the use of a binder into cohesive or integrated sheets of expanded graphite, e.g. webs, papers, strips, tapes, foils, mats or the like (typically referred to commercially as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy with respect to thermal conductivity due to orientation of the expanded graphite particles and graphite layers substantially parallel to the opposed faces of the sheet resulting from high compression, making it especially useful in heat spreading applications. Sheet material thus produced has excellent flexibility, good strength and a high degree of orientation.

The flexible graphite sheet material exhibits an appreciable degree of anisotropy due to the alignment of graphite particles parallel to the major opposed, parallel surfaces of the sheet, with the degree of anisotropy increasing upon compression of the sheet material to increase orientation. In compressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

### DISCLOSURE OF THE INVENTION

The present disclosure relates to a light fixture which includes a circuit board having first and second major surfaces; at least one light emitting diode mounted on the first major surface of the circuit board; an enclosure, such as one formed of a sheet of metal, having two major surfaces and a thermo-mechanical design constant of at least 20 mm-W/m*K and shaped so as to define an opening and a cavity, one of the major surfaces of the material defining the surface of the cavity and the enclosure positioned so as to enclose the second major surface of the circuit board. As used herein, the expression “thermo-mechanical design constant” refers to a characteristic of a material having two major surfaces represented by the average thickness of the material (i.e., the distance between the two major surface of the material) multiplied by its in-plane thermal conductivity. In certain embodiments of the disclosure, the enclosure is formed of a sheet of aluminum, steel, copper or alloys thereof, and has a thermo-mechanical design constant of at least about 440 mm-W/m*K.

The light fixture of the disclosure also includes a heat spreader positioned in thermal contact with both the circuit board and the enclosure, the heat spreader having a surface area at least twice that of the circuit board and a thermo-mechanical design constant of at least 10 mm-W/m*K, more preferably at least about 75 mm-W/m*K; in the most advantageous embodiments, the heat spreader has a thermo-mechanical design constant of at least about 100 mm-W/m*K. In many embodiments, the heat spreader has an in-plane thermal conductivity of at least about 140 W/m*K, more preferably at least about 220 W/m*K (all thermal conductivity measurements provided herein are taken at room temperature, 20° C.). The heat spreader should be at least about 0.075 mm in thickness, up to about 10 mm in thickness. Most commonly, the heat spreader is from about 0.1 mm to about 3 mm in thickness. In some embodiments, the heat spreader is formed of a material selected from the group consisting of copper, aluminum, compressed particles of exfoliated graphite and pyrolytic graphite. In one specific embodiment, the heat spreader is formed of at least one sheet of compressed particles of exfoliated graphite, and, in additional embodiments, the heat spreader extends at least partially across the opening of the enclosure and/or is in thermal contact with the major surface of the enclosure defining the surface of the cavity, such as by the use of an adhesive, rivets, screws or combinations thereof.

A heat sink can also be included, the heat sink positioned so as to compress the heat spreader against the circuit board. Available heat sinks include extruded, injection molded or die-cast metallic heat sinks, or folded fin sheet metal heat sinks, especially aluminum or aluminum alloy heat sinks.

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operations of the invention. Other and further features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a partial, perspective view of an embodiment of an LED light fixture, including a printed circuit board, and a heat spreader in thermal contact with the enclosure and the printed circuit board.

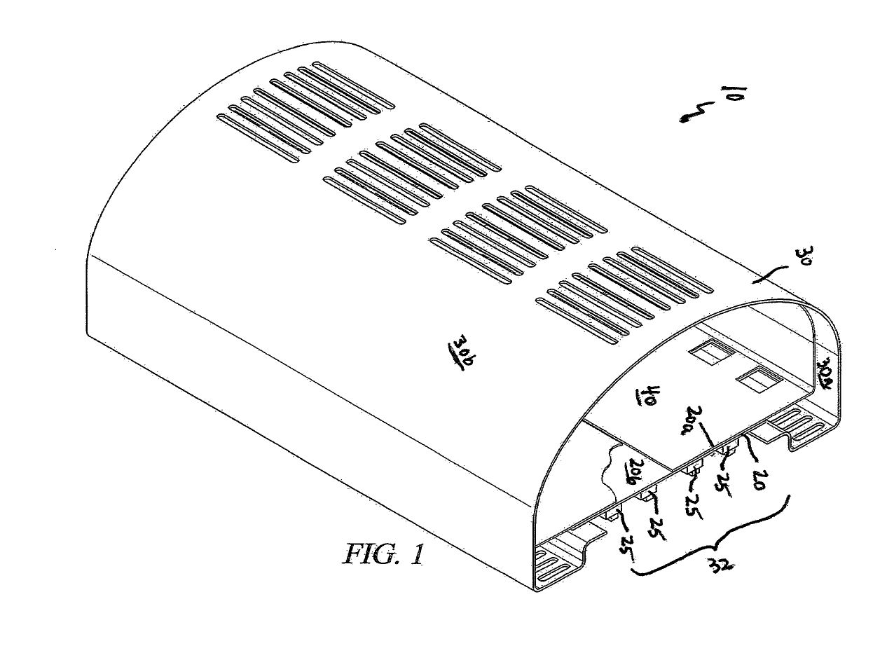

FIG. 2 is a partial, broken-away, perspective schematic view of the light fixture of FIG. 1, showing the heat spreader.

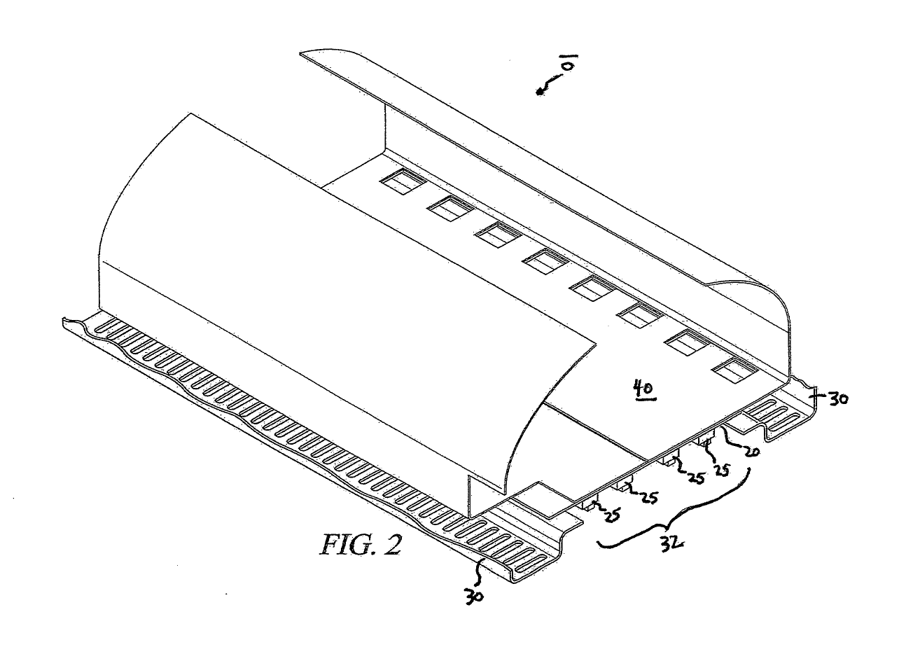

FIG. 3 is a partial, perspective view of another embodiment of an LED light fixture incorporating the enclosure of FIG. 1, including a printed circuit board, and a heat spreader in thermal contact with the enclosure and the printed circuit board, along with a metallic heat sink.

FIG. 4 is a partial, cross-sectional view of another embodiment of an LED light fixture incorporating the enclosure of FIG. 1, including a printed circuit board, and a heat spreader in thermal contact with the enclosure and the printed circuit board, along with a metallic heat sink.

### BEST MODE FOR CARRYING OUT THE INVENTION

As noted, the present disclosure relates to light fixtures incorporating light-emitting diodes, or LEDs. By “light fixture” is meant a device intended for use in providing illumination for an area, either singly or in combination. An LED light fixture uses LEDs as the source of illumination. As is typical, one or more LEDs are mounted on a circuit board which controls the illumination of the LED. One or more such circuit boards can be employed in a light fixture. Of course, it will be readily recognized that it is necessary to enclose the circuit boards of an LED light fixture, both for safety reasons and to prevent damage to the circuit board caused by dust, dirt, or other environmental materials. Indeed, when an LED light fixture is mounted outdoors, such as in use as a streetlight or the like, protection from the elements is even more important. That said, it is also necessary to provide a way of dissipating the heat generated by the LED, to avoid temperature-caused degradation of the performance of the light fixture. Thus, vents and the like are often used, which can provide an entry point for undesirable materials. As such, the present disclosure describes the use of a heat spreader to improve the heat dissipation characteristics of LED light fixtures. In certain embodiments, the heat spreader is formed of one or more sheets of compressed particles of exfoliated graphite.

More specifically, in certain embodiments the LED light fixture of the present disclosure includes a circuit board having first and second major surfaces. As discussed, at least one light emitting diode is mounted on the first major surface of the circuit board. An enclosure is positioned so as to enclose the second major surface of the circuit board. In one embodiment, the enclosure is formed of a material, such as a sheet of metal (sometimes referred to as sheet metal), having two major surfaces and a thermo-mechanical design constant of at least 20 mm-W/m*K. In some embodiments, the thermo-mechanical design constant of the material of the enclosure is at least about 110 mm-W/m*K and in other embodiments it is at least about 270 mm-W/m*K, or at least about 440 mm-W/m*K. In some embodiments, the metal can be aluminum, copper, or steel, or alloys thereof. Generally, the thickness of the material for the enclosure is from about 0.1 mm to about 7 mm; in some embodiments, the material is from about 1.5 mm to about 2.5 mm in thickness.

The enclosure is shaped so as to define an opening and a cavity, with one of the major surfaces of the material defining the surface of the cavity and the other of the major surfaces of the material defines the outer surface of the enclosure. The enclosure is positioned so as to enclose the second major surface of the circuit board, with the cavity of the enclosure positioned about and above the second major surface of the circuit board. The enclosure opening can, in certain embodiments, be designed to vary in size or angle in response to adjustment of the fixture.

In certain embodiments, the outer surface of the enclosure is substantially smooth, especially as compared with the surface of a finned heat sink, in order to reduce the tendency of the outer surface of the light fixture to become fouled, such as with undesirable environmental elements, like bird droppings. By substantially smooth is meant that the surface area of the outer surface of the enclosure is no more than ten times the minimum surface area of a theoretical six-sided box having perfectly-smooth surface finish required to completely envelop the enclosure (excluding any enclosure surface roughness features of less than 25 microns). In more preferred embodiments, surface area of the outer surface of the enclosure is no more than five times the minimum surface area of the outer enclosure; even more preferably it is no more than two times the minimum surface area of the outer surface area of the enclosure.

The light fixture of the disclosure also includes a heat spreader, which, as noted, in some embodiments is formed of one or more sheets of compressed particles of exfoliated graphite. In other embodiments, the heat spreader is formed of a material selected from the group consisting of copper, aluminum and pyrolytic graphite. By “pyrolytic graphite” is meant a graphitic material formed by the heat treatment of certain polymers as taught, for instance, in U.S. Pat. No. 5,091,025, the disclosure of which is incorporated herein by reference.

In certain embodiments of the present disclosure, the enclosure is formed of more than one piece, joined together by adhesive, rivets, screws or combinations thereof. In these circumstances, the joint where the pieces of the enclosure meet can be areas of low thermal connection. The heat spreader can overlay and span these joints and thus “bridge the gap” created by the joint and improve thermal transfer across the joined areas.

In certain embodiments, the heat spreader has a surface area at least twice that of the surface area of the circuit board. By surface area of the heat spreader is meant the surface area of one of the major surfaces of the heat spreader; by surface area of the circuit board is meant the surface area of one of the major surfaces of the circuit board. Alternatively, in other embodiments, surface area refers to the total surface area of the heat spreader and the total surface area of the circuit board, respectively.

In advantageous embodiments, the heat spreader has a thermo-mechanical design constant which differs from that of the material from which the enclosure is formed. Preferably, the heat spreader has a thermo-mechanical design constant that is at least 30% of the thermo-mechanical design constant of the material from which the enclosure is formed, more preferably at least 40% of the thermo-mechanical design constant of the material from which the enclosure is formed. In some embodiments, the heat spreader has a thermo-mechanical design constant of at least about 10 mm-W/m*K, more preferably at least about 75 mm-W/m*K, or at least about 100 mm-W/m*K. In certain preferred embodiments, the heat spreader has a thermo-mechanical design constant of at least about 175 mm-W/m*K. Advantageously, the heat spreader has an in-plane thermal conductivity of at least about 140 W/m*K, more preferably at least about 220 W/m*K, and even more advantageously at least about 300 W/m*K.

As discussed above, the heat spreader is positioned in thermal contact with both the circuit board and the enclosure, in order to effectively dissipate heat from the circuit board to the enclosure, for dissipation to the environment. In additional embodiments, the heat spreader extends at least partially across the opening of the enclosure and/or is in thermal contact with the major surface of the enclosure defining the surface of the cavity, such as by the use of an adhesive, rivets, screws or combinations thereof.

As noted, the heat spreader can be formed of at least one sheet of compressed particles of exfoliated graphite. Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes.

The graphite starting materials used to provide the heat spreader in the present disclosure may contain non-graphite components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has a purity of at least about eighty weight percent. More preferably, the graphite employed for the heat spreader of the present invention will have a purity of at least about 94%. In the most preferred embodiment, the graphite employed will have a purity of at least about 98%.

Compressed exfoliated graphite materials, such as graphite sheet and foil, are coherent, with good handling strength, and are suitably compressed, e.g. by roll pressing, to a thickness of about 0.05 mm to 3.75 mm and a typical density of about 0.4 to 2.0 g/cc or higher. Indeed, in order to be consider “sheet,” the graphite should have a density of at least about 0.6 g/cc, and to have the flexibility required for the present invention, it should have a density of at least about 1.1 g/cc, more preferably at least about 1.6 g/cc. While the term “sheet” is used herein, it is meant to also include continuous rolls of material, as opposed to individual sheets.

If desired, sheets of compressed particles of exfoliated graphite can be treated with resin and the absorbed resin, after curing, enhances the moisture resistance and handling strength, i.e. stiffness, of the graphite article as well as “fixing” the morphology of the article. Suitable resin content is preferably at least about 5% by weight, more preferably about 10 to 35% by weight, and suitably up to about 60% by weight. Resins found especially useful in the practice of the present invention include acrylic-, epoxy- and phenolic-based resin systems, fluoro-based polymers, or mixtures thereof. Suitable epoxy resin systems include those based on diglycidyl ether of bisphenol A (DGEBA) and other multifunctional resin systems; phenolic resins that can be employed include resole and novolac phenolics. Optionally, the flexible graphite may be impregnated with fibers and/or salts in addition to the resin or in place of the resin. Additionally, reactive or non-reactive additives may be employed with the resin system to modify properties (such as tack, material flow, hydrophobicity, etc.).

When employed as a heat spreader in accordance with the current disclosure, a sheet of compressed particles of exfoliated graphite should have a density of at least about 0.6 g/cc, more preferably at least about 1.1 g/cc, most preferably at least about 1.6 g/cc. From a practical standpoint, the upper limit to the density of the graphite sheet heat spreader is about 2.0 g/cc. The sheet should be no more than about 10 mm in thickness, more preferably no more than about 2 mm and most preferably not more than about 0.5 mm in thickness. When more than one sheet is employed, the total thickness of the sheets taken together should preferably be no more than about 10 mm. One graphite sheet suitable for use as the heat spreader in the present disclosure is commercially available as eGRAF material, from GrafTech International Holdings Inc. of Parma, Ohio.

In certain embodiments, a plurality of graphite sheets may be laminated into a unitary article for use in the enclosure and LED light fixture disclosed herein. The sheets of compressed particles of exfoliated graphite can be laminated with a suitable adhesive, such as pressure sensitive or thermally activated adhesive, therebetween. The adhesive chosen should balance bonding strength with minimizing thickness, and be capable of maintaining adequate bonding at the service temperature at which heat transfer is sought. Suitable adhesives would be known to the skilled artisan, and include acrylic and phenolic resins.

The graphite sheet(s) should have a thermal conductivity parallel to the plane of the sheet (referred to as “in-plane thermal conductivity”) of at least about 140 W/m*K for effective use. More advantageously, the thermal conductivity parallel to the plane of the graphite sheet(s) is at least about 220 W/m*K, most advantageously at least about 300 W/m*K. From a practical standpoint, sheets of compressed particles of exfoliated graphite having an in-plane thermal conductivity of up to about 600 W/m*K are all that are necessary for the majority of lighting fixture designs.

In addition to the in-plane thermal conductivity of the sheet(s) of compressed particles of exfoliated graphite, the through-plane thermal conductivity is also relevant. More particularly, the anisotropic ratio of the sheet (as defined hereinbelow) is relevant. In certain embodiments, the through-plane thermal conductivity of the sheet of compressed particles of exfoliated graphite should be less than about 12 W/m*K; in other embodiments, the through-plane thermal conductivity is less than about 10 W/m*K. In still other embodiments, the through-plane thermal conductivity of the sheet of compressed particles of exfoliated graphite is less than about 7 W/m*K. In a particular embodiment, the through-plane thermal conductivity of the sheet is at least about 1.5 W/m*K.

The expressions “thermal conductivity parallel to the plane of the sheet” and “in-plane thermal conductivity” refer to the fact that a sheet of compressed particles of exfoliated graphite has two major surfaces, which can be referred to as forming the plane of the sheet; thus, “thermal conductivity parallel to the plane of the sheet” and “in-plane thermal conductivity” constitute the thermal conductivity along the major surfaces of the sheet of compressed particles of exfoliated graphite. The expression “through-plane thermal conductivity” refers to the thermal conductivity between or perpendicular to the major surfaces of the sheet.

In order to access the anisotropic properties of the graphite sheet, the anisotropic ratio of the sheet may be at least about 50; in other embodiments, the anisotropic ratio of the sheet is at least about 70. Generally, the anisotropic ratio need not be any greater than about 500, more preferably no greater than about 250. The anisotropic ratio is calculated by dividing the in-plane thermal conductivity by the through-plane thermal conductivity. Thus, a sheet of compressed particles of exfoliated graphite having an in-plane thermal conductivity of 350 W/m*K and a through-plane thermal conductivity of 5 W/m*K has a thermal anisotropic ratio of 70.

In certain embodiments, the heat spreader can be coated with a layer of an electrically insulating material, such as a plastic like polyethylene terephthalate (PET), for electrical isolation.

Referring now to the drawings, in which not all reference numbers are shown in every drawing, for clarity purposes, an LED light fixture in accordance with the disclosure is denoted by the reference numeral 10. Light fixture 10 includes a circuit board 20 having first and second major surfaces, 20a and 20b. At least one light emitting diode 25 is mounted on first major surface 20a of circuit board 20. Light fixture 10 also includes an enclosure 30, having two major surfaces 30a and 30b. Enclosure 30 is shaped so as to define an opening 32 and a cavity 33, where one of the major surfaces 30a defining the surface of cavity 33 and enclosure 30 positioned so as to enclose second major surface 20b of circuit board 20; the second of the major surfaces of enclosure 30, denoted 30b, is substantially smooth, as described hereinabove.

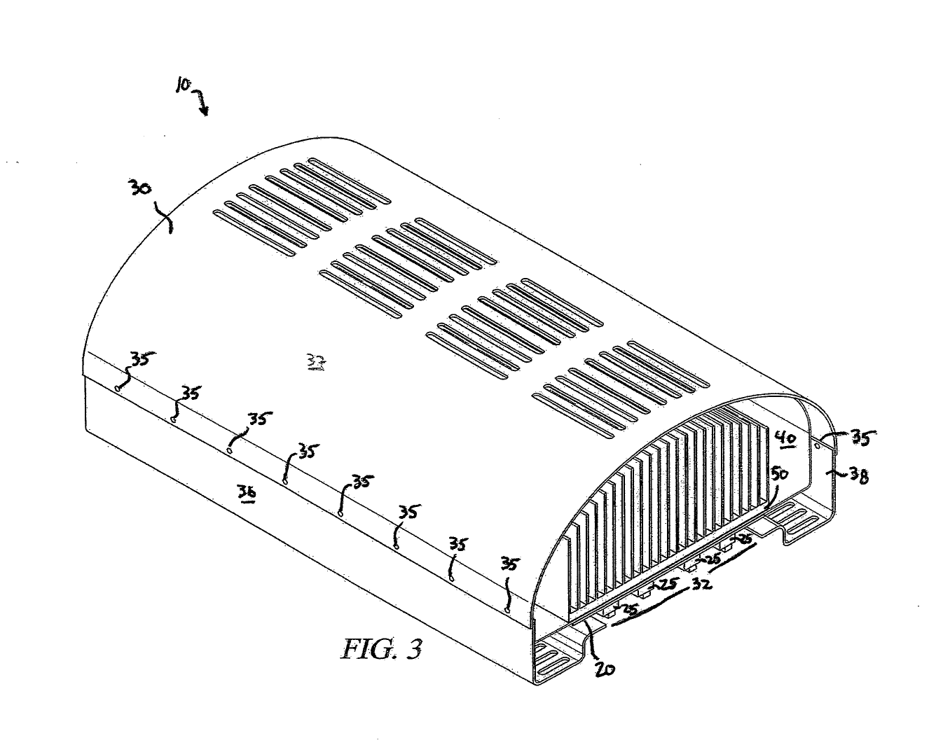

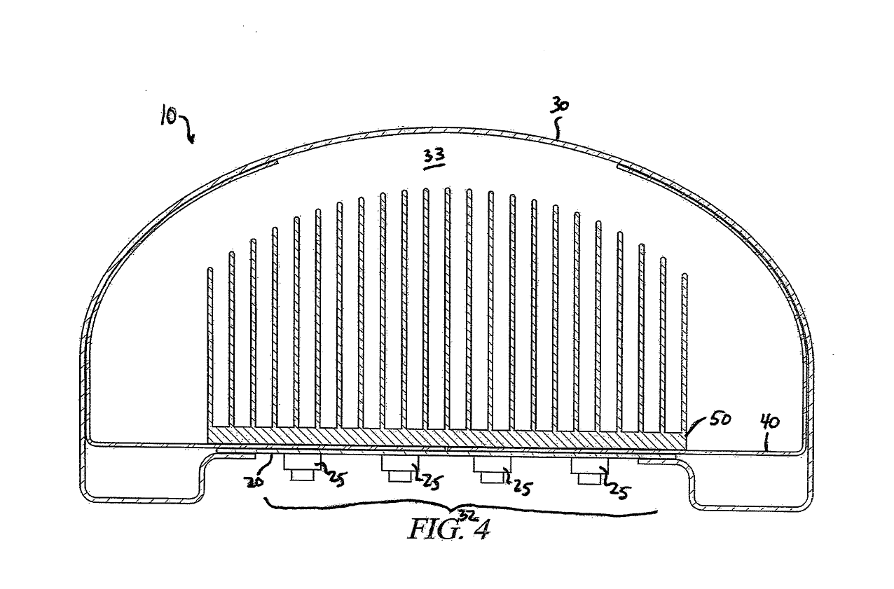

Light fixture 10 also includes a heat spreader 40 having a surface area at least twice that of circuit board 20, heat spreader 40 positioned in thermal contact with both circuit board 20 and enclosure 30. FIGS. 3 and 4 show the embodiment where a heat sink 50 is also present, heat sink 50 positioned so as to compress heat spreader 40 against circuit board 20 to facilitate thermal transfer.

In embodiments where enclosure 30 is formed of more than one piece, as illustrated in FIG. 3, as enclosure pieces 36, 37 and 38, joined together by, e.g., rivets 35, the joint where the pieces 31, 32 and 33 of enclosure 30 meet can be areas of low thermal connection. Heat spreader 20 overlays and spans these joints and thus improves thermal transfer across the joined areas of enclosure 30.

Thus, by the practice of the foregoing disclosure, thermal dissipation in an LED light fixture equivalent to or better than that accomplished by use of an aluminum heat sink, without many of the disadvantages thereof, can be had.

All cited patents and publications referred to in this application are incorporated by reference.

The invention thus being described, it will be apparent that it may be varied in many ways. Such variations are not to be regarded as a departure from the spirit and scope of the present invention and all such modifications as would be obvious to one skilled in the art are intended to be included in the scope of the following claims.

What is claimed is:

1. A light fixture, comprising
a. a circuit board having first and second major surfaces;
b. at least one light emitting diode mounted on the first major surface of the circuit board;
c. an enclosure formed of a material having two major surfaces and a thermo-mechanical design constant of at least 20 mm-W/m*K and shaped so as to define an opening and a cavity, a first one of the major surfaces of the material defining the surface of the cavity and the enclosure positioned so as to enclose the second major surface of the circuit board;
d. a heat spreader having a surface area at least twice that of the surface area of the circuit board and a thermo-mechanical design constant of at least 10 mm-W/m*K, the heat spreader positioned in thermal contact with both the circuit board and the enclosure, wherein thermo-mechanical design constant of a material is defined by thermal conductivity of the material multiplied by its average thickness.

2. The light fixture of claim 1, wherein the heat spreader is formed of a material selected from the group consisting of copper, aluminum, compressed particles of exfoliated graphite and pyrolytic graphite.

3. The light fixture of claim 1, wherein the heat spreader has an in-plane thermal conductivity of at least about 140 W/m*K.

4. The light fixture of claim 3, wherein the heat spreader is formed of at least one sheet of compressed particles of exfoliated graphite.

5. The light fixture of claim 1, wherein the enclosure is formed of a sheet of metal.

6. The light fixture of claim 5, wherein the enclosure has a thermo-mechanical design constant of at least about 110 mm-W/m*K.

7. The light fixture of claim 1, wherein the heat spreader extends at least partially across the opening of the enclosure.

8. The light fixture of claim 1, wherein the heat spreader is in thermal contact with the major surface of the enclosure defining the surface of the cavity.

9. The light fixture of claim 1, further comprising a heat sink positioned so as to compress the heat spreader against the circuit board.

10. The light fixture of claim 1, wherein the enclosure opening is designed to vary in size or angle in response to adjustment of the fixture.

11. The light fixture of claim 1, wherein the major surface of the material defining the outer surface of the enclosure is substantially smooth.

12. The light fixture of claim 1, wherein the enclosure is formed of more than one piece having a joint where the pieces of the enclosure meet, and further wherein the heat spreader overlays the joint and improves thermal transfer across the joint.

13. An enclosure for a light fixture, comprising a material having two major surfaces and a thermo-mechanical design constant of at least 20 mm-W/m*K and shaped so as to define an opening and a cavity, with one of the major surfaces of the material defining the surface of the cavity, and a heat spreader having a thermo-mechanical design constant of at least 10 mm-W/m*K, the heat spreader extending at least partially across the opening and in thermal contact with the surface of the material which defines the surface of the cavity, wherein the thermo-mechanical design constant is defined by the thermal conductivity multiplied by average thickness.

14. The enclosure of claim 13, wherein the heat spreader is formed of a material selected from the group consisting of copper, aluminum, compressed particles of exfoliated graphite and pyrolytic graphite.

15. The enclosure of claim 14, wherein the heat spreader has an in-plane thermal conductivity of at least about 220 W/m*K.

16. The enclosure of claim 15, wherein the heat spreader is formed of at least one sheet of compressed particles of exfoliated graphite.

17. The enclosure of claim 13, wherein the material comprises a sheet of metal.

18. The enclosure of claim 17, wherein the material has a thermo-mechanical design constant of at least about 110 mm-W/m*K.

19. The enclosure of claim 13, wherein the major surface of the material defining the outer surface of the enclosure is substantially smooth.

20. The enclosure of claim 13, wherein the thermo-mechanical design constant of the heat spreader differs from the thermo-mechanical design constant of the material.

21. The enclosure of claim 13, wherein the material is formed of more than one piece having a joint where the pieces of the material meet, and further wherein the heat spreader overlays the joint and improves thermal transfer across the joint.
